(19) United States
(12) Patent Application Publication
(10) Pub. No.: US 2007/0078820 A1
(43) Pub. Date: Apr. 5, 2007

(54) Mindmatch: method and system for mass customization of test preparation

(76) Inventor: Eva Lana, New York, NY (US)

Correspondence Address: EVA LANA, 511 AVENUE OF THE AMERICAS # 266, NEW YORK, NY, 10011, US

(21) Appl. No.: 09/851,636

(22) Filed: May 8, 2001

Related U.S. Application Data
(60) Provisional application No. 60/203,184, filed on May 8, 2000.

(51) Int. Cl. G06F 17/30

(52) U.S. Cl. 707/3

(57) ABSTRACT

The invention is a method and system for providing dynamic, customized test preparation using a computer assisted search engine which retrieves: (1) specific solutions to sets of questions that a particular user is answering incorrectly, (2) teaching modules on how to solve each general case of question that appears within the searched set, and (3) new assignments of questions similar in type to the searched set. The search function is fueled by a unique issue-based classification system, and triggered by a series of diagnostic tests that are designed to evaluate a user's weakness. The user begins the cycle by inputting his/her test results and the system matches the performance of the user and enables the user to gain training mainly in his/her weakneses. The system includes media rich teaching tools, referred to as the “Living Page” because the question text is animated in a unique manner that highlights the steps of solution. As the user continues to train, the search engine continues to adapt to the user by retrieving materials that best suit the user at that instant. The user's history is recorded, evaluated and updated with each visit to the website, where this service will be hosted and principally provided to online users. The user may even design, within certain predetermined parameters, a self-prescribed course of study. The two main user driven modalities are referred to as “The Hedghog” and “The Fox”: the former retrieves information along one specific line of inquiry (eg, user seeks to see every solution for every question of a single type), while the latter enables the user to scope the boundaries of the entire field and review preselected examples (eg, user requests information on every question under a particular category or issue and also wants to know how many other categories would need to be studied before the field is exhausted). Finally, the digital product achieves customization by assigning a virtual tutor, referred to as the “Genie” to each user. The user will be able to select one of several personas to digitally accompany and plan the entire course of study through a series of emails and computer generated schedules and reminders. The user selected Genie will also proctor exams and evaluate replies to homework. In the event that the digital solutions do not provide adequate training, the program is designed with a “Hard Stop” button, so that the user may send an email to a live instructor and have his/her substantive question replied to by a trained teacher. This method of providing test preparation will enable the user to register for instruction in a variety of ways, including: (1) according to time spent on website (i.e., number and/or length of visits to visit), (2) by subject (eg, a bundle of services triggered by a user's response to a subject test would include solutions, training sessions and a customized drill set) or (3) as a way of enhancing live course delivery and CD-Rom study aids.

This nonprovisional patent application claims the filing date benefit of Provisional Application No. 60/203,184, filed 05/08/2000.

### BRIEF SUMMARY OF THE INVENTION

The invention is a method and system for performing customized test preparation, assisted by a unique search agent which retrieves test questions and related information (such as lectures relating and solutions to said questions). The search function is fueled by an issue-based classification system which is highly responsive to the user's test performance. The system comprises a multimedia database, whose quanta of information each possess one or more predefined issues, so that the user's responses to test questions &i can activate an issue-based search. A typical search retrieves a constellation of preparatory materials including: a lecture video clip, an animated solution to a test question the user answered incorrectly, and a drill set comprised of questions similar to those the user answered incorrectly. Initially, a user is tested and the user's incorrect responses serve to pinpoint issues that form the basis of said search for preparatory materials. As the user continues to train, the search engine continues to adapt to the user by retrieving materials that best suit the user at that instant. The user's performance is recorded, evaluated, updated and activated through a history of interaction with the system.

However, the user can deactivate the system and design, within certain predetermined parameters, a self-prescribed course of study. Through continued intearction with the program, the user gains a personalized, computer-assisted iterative course of study whose specificity surpasses that of existing courses of preparation.

The contents of the database are typically recorded as simple text, graphics, animated display, audio description and video clips. The system will comprise: lectures, test questions, explanations and refutations of answers to questions, and diagnostic materials. These components will be linked in the manner specified herein to form a dynamic databse with a user interface. Both the content and the classification system have been developed for the Law School Admission Test (LSAT), the exam that has provided the inspiration and the cause for immediate application of this invention. Similar systems are also being developed for subjects including, but not limited to: the Scholastic Assessment Test (SAT), the Graduate Record Exam (GRE), mathematics, language and science. These and other aspects of the invention will be apparent from and elucidated with reference to the embodiments described hereinafter.

### BRIEF DESCRIPTION OF THE DRAWINGS

FIG. 1 is a flow chart of the system in which the method of the invention is used. The flow chart offers a general survey with the most important elements. The process begins with a Diagnostic Test, which is used to activate the initial customized search for preparatory materials. Materials retrieved by the search agent typically contain: text, video clips of lectures, animated problem solving displays demonstrating methods of solution, and customized drill sets. The first phase of the process (referred to as Theory) is intended to teach skills that will assist in the solution of test questions, and at its conclusion, a theory quiz is administered and the results of the quiz generate yet another customized search for preparatory materials. With theory satisfied, the user enters the Application phase, where questions are no longer presented by category, but rather are administered in the sequence customary for an actual test. Application begins with a full length test, which is scored and the incorrect responses provided by the user become the stimuli for a customized search for solutions and further questions of the same type. For a typical incorrect response, the search agent retrieves: an explanation of the correct response (which may include animated solutions as well as lectures explaining the method), a refutation (if appropriate) for the incorrect response, and a set of N questions that are the best matches for the stimulus question. Thus, for each scored test, the process will generate a customized drill set containing (P×N) questions, where P is the number of incorrect responses provided by the user and N is the number of matches found. The user can program the value of N and modify the cycle, by following the alternative Crash Course cycle—a route that either sidesteps the theory phase (i.e., taking a problems-based tack that utilizes theoretical materials on a need to know basis) or calls for enhanced theory. In addition, a user can activate an independednt search by entering search-sensitive fields, such as a question number from a prior exam. This iterative course cycle will continue for as long as the user interacts with the system.

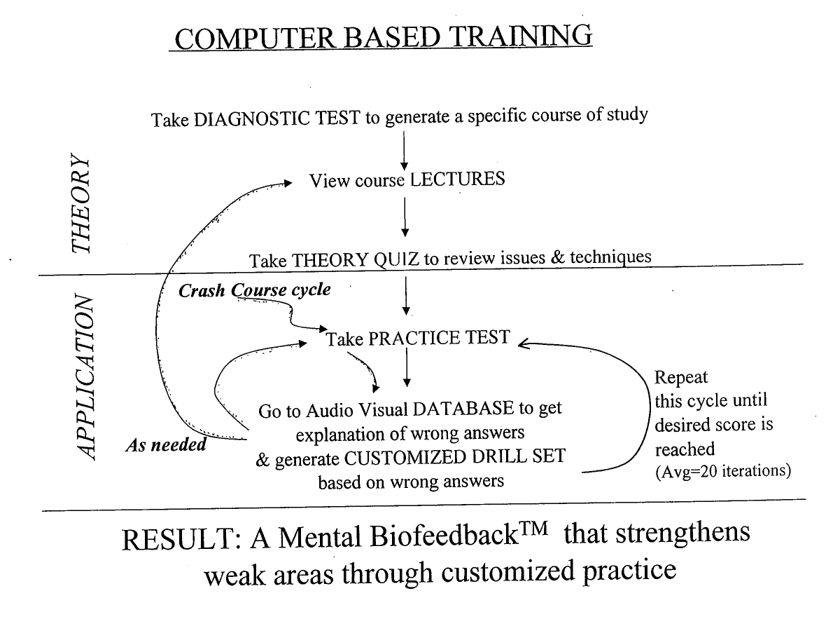

FIG. 2 shows details of the elements of the Application phase, which was set forth in FIG. 1. This diagram refers specifically to the Law School Admission Test (LSAT).

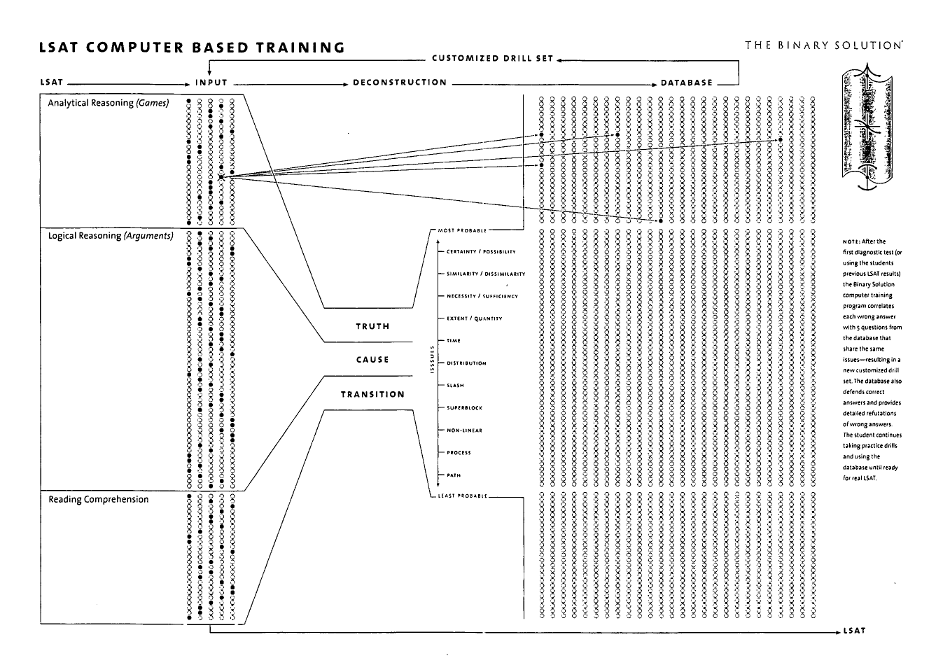

FIG. 3 shows the rationale behind the classification system that fuels the search engine.

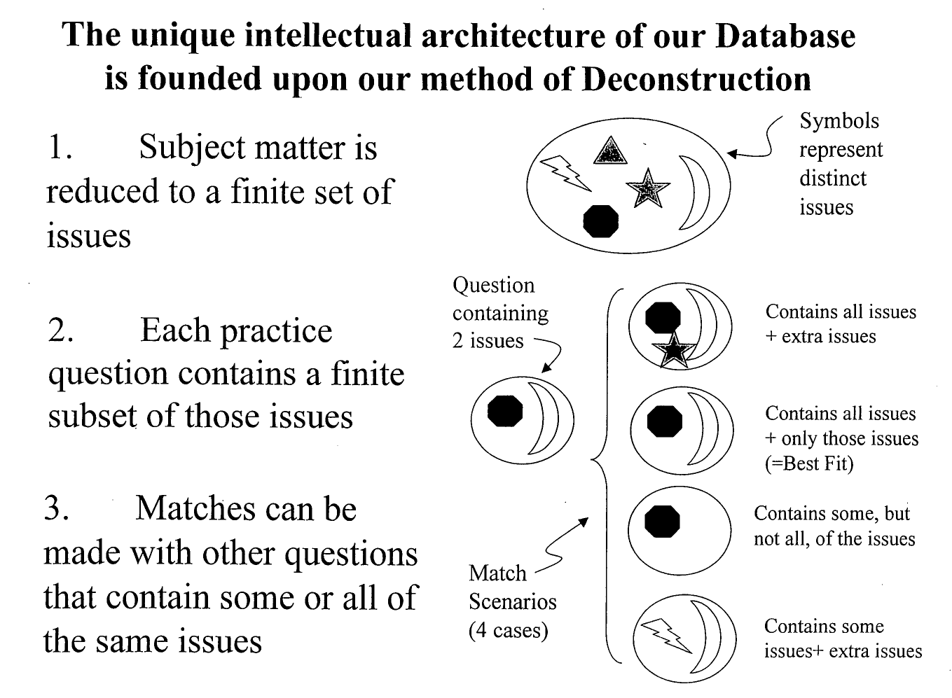

FIG. 4 shows some details of the issue-based search mechanism for the LSAT.

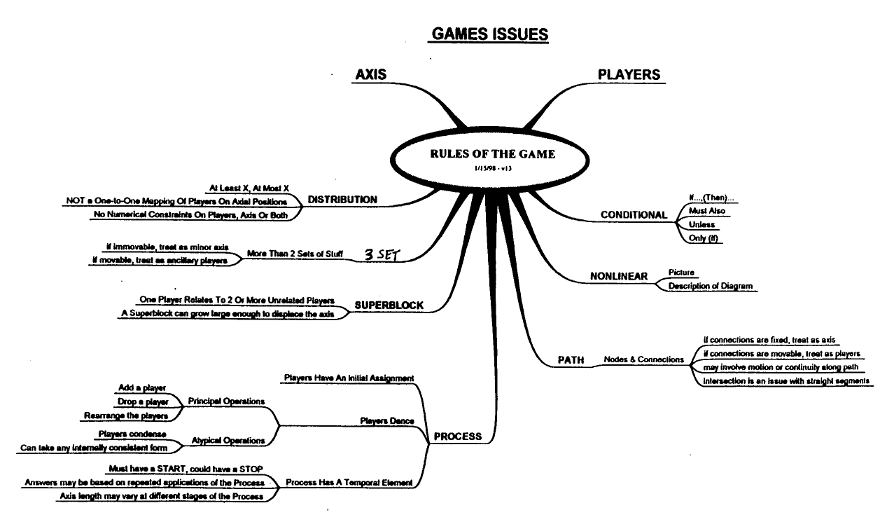

FIG. 5 shows an exploded view of the classification system for the LSAT

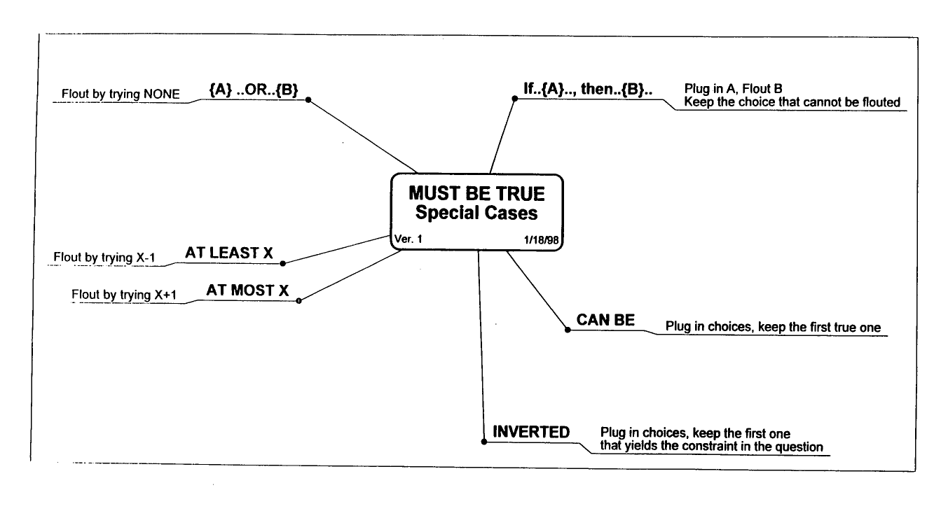

FIG. 6 shows the inspiration for the prefered embodiment of the graphical user interface.

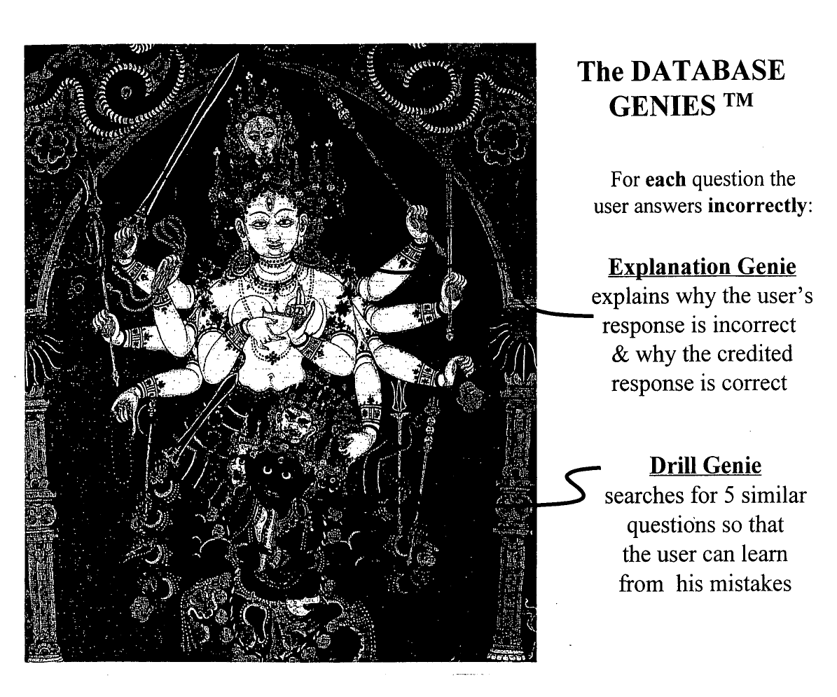

While preferred embodiments of the invention have been shown and described in some detail, it will be readily understood and appreciated that numerous omissions, changes and additions may be made without departing from the spirit and scope of the present invention.

What I claim as my invention is:

1. a test preparation system for use by a student comprising:
a multimedia database which includes: test questions and their solutions, lectures, video clips, text, graphics, animated display, and audio description, structured in a novel manner so that information from a user's input can generate a customized course of study for the user;
a unique, issue-based classification system which enables a search agent to construct customized drill sets and preparation tools (eg, lectures and solutions) based on a user's incorrect responses to test questions;
an iterative, computer-assisted preparation cycle which structures the user's course of study and his access to embedded expertise and unique methods of solution;
an adaptive search agent that evaluates the user's test performance and retrieves preparatory materials that best suit the user at that instant.
